(19) United States
(12) Patent Application Publication
(10) Pub. No.: US 2018/0164080 A1
(43) Pub. Date: Jun. 14, 2018

(54) LAND AND AIR DEFENSE SYSTEM HAVING DRONES

(71) Applicant: RICHARD CHI-HSUEH, SAN DIEGO, CA (US)

(72) Inventor: RICHARD CHI-HSUEH, SAN DIEGO, CA (US)

(21) Appl. No.: 15/678,318

(22) Filed: Aug. 16, 2017

Related U.S. Application Data
(60) Provisional application No. 62/377,675, filed on Aug. 22, 2016.

(51) Int. Cl. F41H 11/02; G05D 1/10; B64C 39/02; G01S 13/88; G01S 7/04

(52) U.S. Cl. CPC F41H 11/02; G05D 1/104; B64C 39/024; B64C 2201/108; G01S 7/04; B64C 2201/12; B64C 2201/027; G01S 13/88

(57) ABSTRACT

A land and air defense system having drones is disclosed. It mainly comprises a radar defense warning network having a radar and a signal transmitting module; a central computer defense system wirelessly connected to the radar defense warning network and having a central computer, a signal receiving module, a processor, a database, and an information display module; and a plurality of drone bases wirelessly connected to the central computer defense system. Each of the plurality of drone bases is disposed with a plurality of drones and a wireless charger module, and each of the plurality of drones is disposed with a mobile device and a net ejector.

### BACKGROUND OF THE INVENTION

### Field of the Invention

The present invention relates to a land and air defense system having drones, especially to a drone defense system which can intercept foreign missiles or fighter aircrafts before the missiles or the fighter aircrafts reach and attack a target subject. Thus, it can used to protect the national defense military facilities and bases and achieve the purpose of defense.

### Description of Related Art

The traditional defense systems usually launch missiles after they detects the foreign missiles or fighter aircrafts entering into a defensive area to deter the intruders from reaching the target. If the defense systems subsequently launch other missiles only after they find the first launched missiles do not accurately hit or intercept the foreign missiles or fighter aircrafts, they may cause the failure of interception due to a time delay.

Referring to an international patent WO 2013020911 A1, published on 14^{th} Feb. 2013, a device and method for protecting objects is revealed for protecting objects against airborne assault ammunition, (especially in the vicinity of the object) and significantly increasing the probability to successfully fight against RAM threats. The method for protecting objects (such as mortar shells which are emitted from at least one weapon) from assault ammunition is characterized by the following steps: determining a blocking volume around an object; monitoring a space inside and outside the blocking volume; performing a threat analysis of the flight path of the assault ammunition; defining at least one fictitious piercing point of the flight path of the assault ammunition by the fictitious shell of the blocking volume; and triggering at least one weapon for delivering at least one defensive projectile.

However, the failure rate of using existing methods or devices to intercept missiles or fighter aircrafts is still high. How to invent a better land and air defense system for deterring an unexpected intruding object and ensuring the security of the national defense military facilities and bases is important for future research and development of the security system.

There is room for improvement and there is a need to provide a novel defense system that overcomes the shortcomings mentioned above.

### SUMMARY OF THE INVENTION

Therefore, it is a primary object of the present invention to provide a land and air defense system having drones in which at least one drone is used to reach an intrusion area quickly for intercepting the foreign missiles or fighter aircrafts before the missiles or the fighter aircrafts reach and attack a target subject so as to ensure the security of the national defense military facilities and bases.

In order to achieve the above object, a land and air defense system having drones according to the present invention mainly includes a radar defense warning network, a central computer defense system wirelessly connected to the radar defense warning network, and a plurality of drone bases wirelessly connected to the central computer defense system. The radar defense warning network is disposed with a radar and a signal transmitting module. The central computer defense system is disposed with a central computer, a signal receiving module, a processor, a database, and an information display module electrically connected to each other. Each of the plurality of drone bases is disposed with a plurality of drones and a wireless charger module for supplying electrical power to the plurality of drones, and each of the plurality of drones is disposed with a mobile device and a net ejector.

When the radar defense warning network detects a foreign missile or fighter aircraft flying into a defensive area of the radar defense warning network, an input signal is generated and wirelessly transmitted to the central computer and the signal receiving module of the central computer defense system by the signal transmitting module for a further comparison by the processor and the database. Then the information display module displays a comparison result. If the comparison result indicates that the defensive area is attacked by the foreign missile or fighter aircraft, the processor simultaneously transmits an output signal to the mobile devices of the plurality of drone bases to actuate the plurality of drones to conduct an air interception.

The information display module of the central computer defense system outputs a flight positioning instruction into the plurality of drones in the plurality of drone bases for driving the plurality of drones to fly to an air intercepting position so as to form at least one defense network having a lattice meshwork for intercepting the foreign missiles or fighter aircrafts. Preferentially, the input signal and the output signal are encrypted signals.

The net ejector has a catching net and receives a net ejecting order from the central computer defense system by wireless communication to eject the catching net. Moreover, an outer edge of the catching net is further disposed with a loading object so that the catching net can be easily expanded by a current of air.

The central computer defense system conducts a 24-hour monitoring of airspace and territory by the radar defense warning network which is established by a ground radar station, a maritime radar station and an aircraft radar.

Accordingly, the present invention can deter the intruders, e.g. foreign missiles or fighter aircrafts with armed personnel, from invading airspace or territory and attacking the target. Especially before the missiles or fighters launched by the enemy or terrorist organization have not yet entered the airspace or territory and attacked their targets, the air radar of the radar defense warning network can detect the flying position of the missiles or the fighter aircrafts and transmit information to the central computer defense system so that a computer system or a monitoring personnel can immediately start the plurality of drones flying to the flight paths of the missiles or near the fighter aircrafts. When the plurality of drones arrive at the flying position prior to arrival of the missiles or the fighter aircrafts, they keep flying and start to arrange in a lattice meshwork in the air. Then the plurality of catching nets are ejected from the plurality of drones to form a huge intercept network in the air. Therefore, an enemy's missiles or fighter entering into the airspace or territory may be captured by the intercept network immediately and fail to approach to the target subject or they may be exploded due to hitting the drone with great speed.

Additionally, the land and air defense system having drones of the present invention can be combined with the use of wireless telecommunications, Internet-of-Things (IoT), mobile devices, and APP related techniques to track and position intruding object and actuate the drones for defensive interceptions on land and air. In such a case, besides the central computer defense system, the APP platform real-time monitored and controlled by the mobile devices can also conduct the defensive layout and capture action immediately.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic diagram showing an embodiment according to the present invention;

FIG. 2 is a system block diagram showing an embodiment according to the present invention;

FIG. 3 is a schematic diagram showing a plurality of drones aggregate to form a lattice meshwork according to the present invention;

FIG. 4 is a partial enlarged diagram of FIG. 3 showing a plurality of catching nets are ejected from a plurality of net ejectors of the drones to form a huge intercept network;

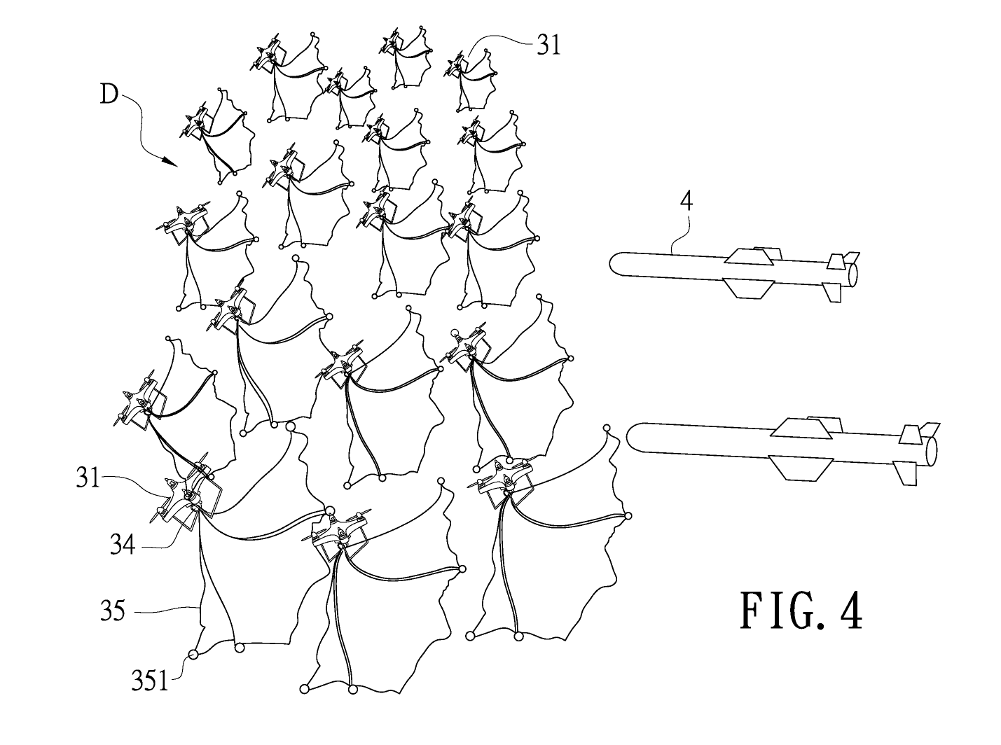

FIG. 5 is a schematic diagram showing a catching net is ejected from a net ejector of a drone;

FIG. 6 is a schematic diagram showing a drone successfully intercepts a missile according to the present invention.

5

### DETAILED DESCRIPTION OF THE PREFERRED EMBODIMENT

In order to learn purposes and functions of the present invention, please refer to the following embodiments, related figures and detailed descriptions.

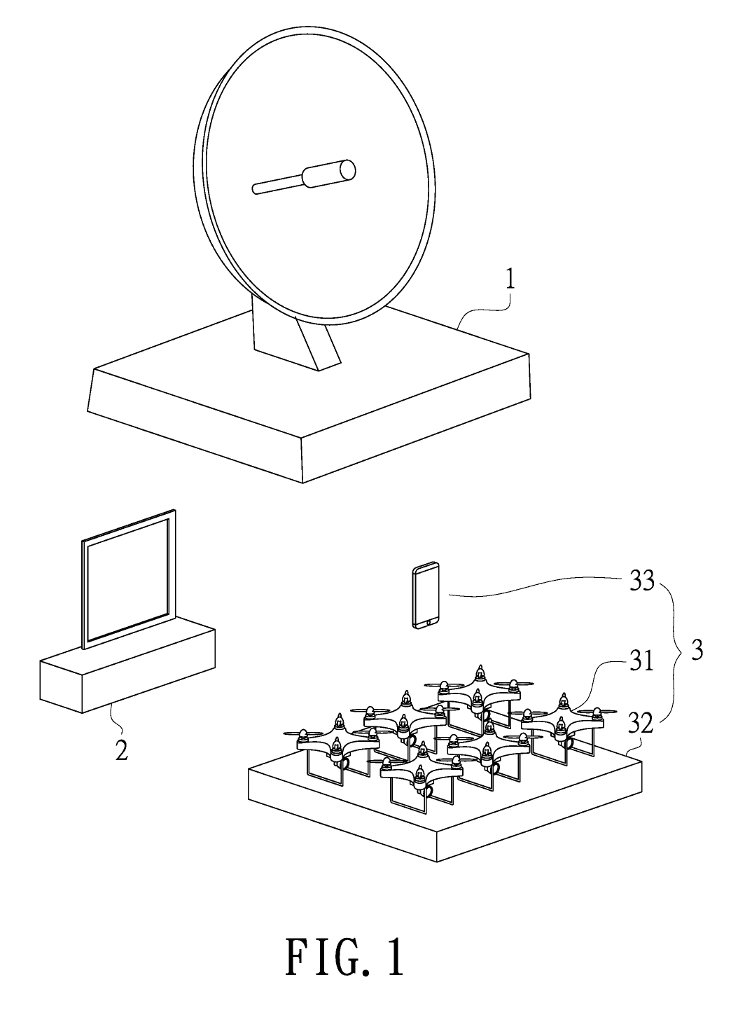

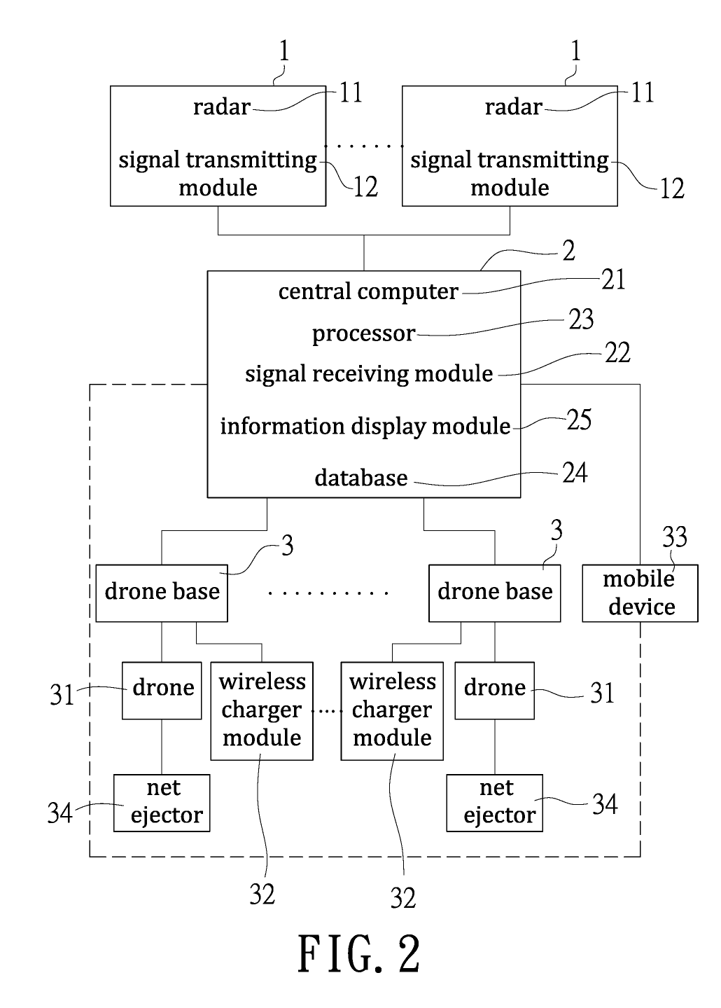

Refer to FIG. 1 and FIG. 2, a schematic diagram and a system block diagram showing an embodiment according to the present invention are revealed. A land and air defense system having drones mainly includes a radar defense warning network (1), a central computer defense system (2), and a plurality of drone bases (3).

Specifically, the radar defense warning network (1) is disposed with a radar (11) and a signal transmitting module (12). The central computer defense system (2) is wirelessly connected to the radar defense warning network (1) and disposed with a central computer (21), a signal receiving module (22), a processor (23), a database (24), and an information display module (25) electrically connected to each other. The central computer defense system (2) conducts a 24-hour monitoring of airspace and territory by the radar defense warning network (1) which is established by a ground radar station, a maritime radar station and an aircraft radar. The plurality of drone bases (3) is wirelessly connected to the central computer defense system (2). Each of the plurality of drone bases (3) is disposed with a plurality of drones (31) and a wireless charger module (32), and each of the plurality of drones (31) is further disposed with a mobile device (33) and a net ejector (34). The net ejector (34) has a catching net (35) and receives a net ejecting order from the central computer defense system (2) by wireless communication to eject the catching net (35). Furthermore, an outer edge of the catching net (35) is provided with a loading object (351) so as to allow the catching net (35) to expand easily by a current of air. The wireless charger module (32) is used to supply electrical power to the plurality of drones (31) so that the plurality of drones (31) can be actuated at any time to intercept foreign missiles or fighter aircrafts in the air.

Hereinafter, an exemplary embodiment of the present invention will be described in detail with reference to the accompanying drawings.

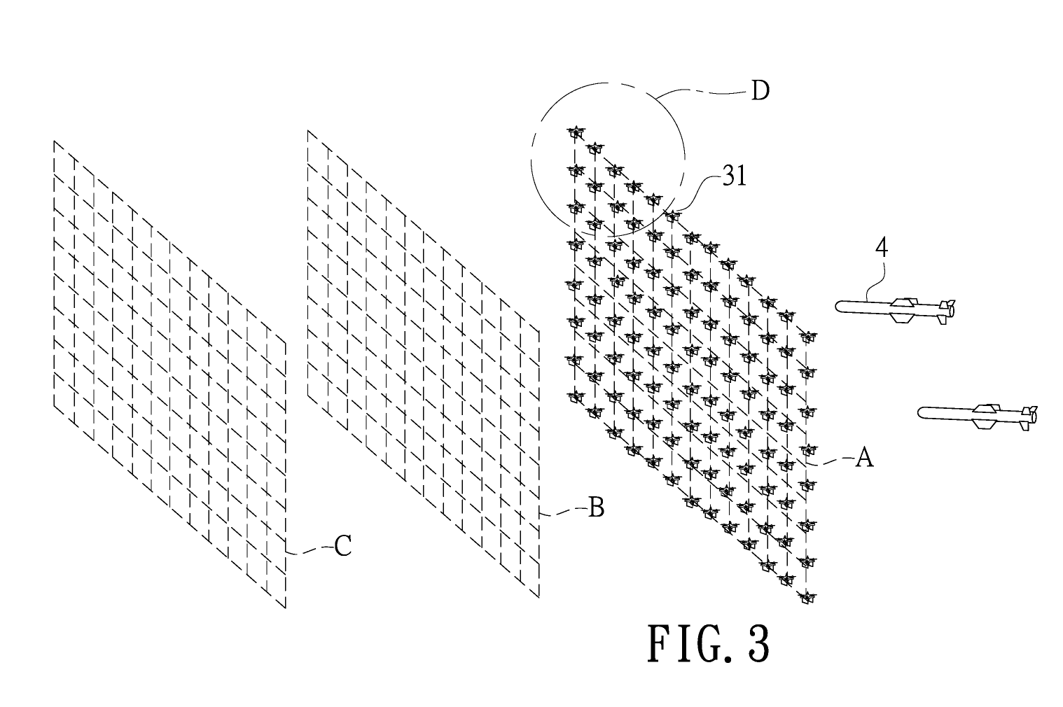

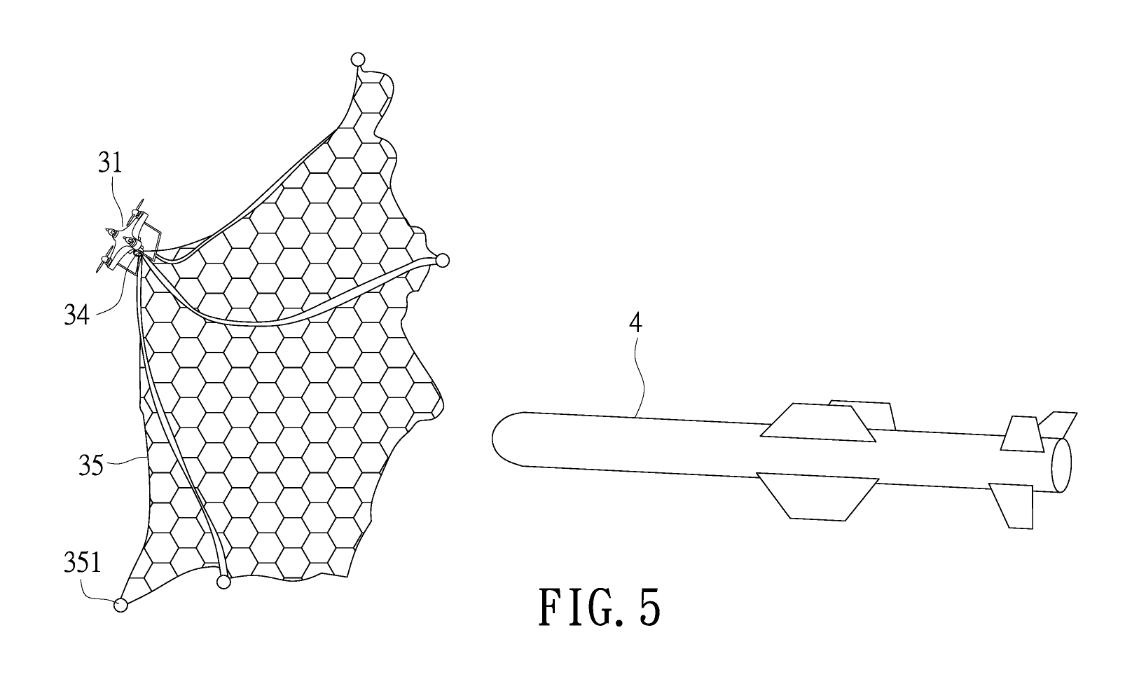

In use of the drones (31) as shown in FIG. 3- FIG. 5, when the radar (11) of the radar defense warning network (1) detects foreign missiles (4) or a fighter aircrafts flying into a defensive area of the radar defense warning network (1), the signal transmitting module (12) wirelessly transmits an input signal to the central computer (21) and the signal receiving module (22) of the central computer defense system (2) or to a monitoring personnel. The processor (23) compares the input signal with the database (24) and then displays the comparison result on the information display module (25) and further transmits an output signal to the APP module of the mobile device (33) of each of the plurality of drone bases (3). If the comparison result indicates that the defensive area may be attacked by the foreign missiles (4) or the fighter aircrafts, the central computer defense system (2) will immediately actuate the plurality of drones (31) to conduct an interception in the air.

At this time, the information display module (25) of the central computer defense system (2) outputs a flight positioning instruction into the plurality of drones (31) in the plurality of drone bases (3) for driving the plurality of drones (31) to fly to an air intercepting position so as to form at least one defense network having a lattice meshwork (D) for intercepting the foreign missiles (4) or fighter aircrafts. As shown in FIG. 3, a first defense network (A), a second defense network (B) and a third defense network (C) are formed near the flight paths of the foreign missiles (4) and ready to intercept the missiles (4). Preferentially, the input signal and the output signal are encrypted signals and the communication between the central computer (21) and the drones (31) can be transmitted with encrypted telecommunications to prevent the enemy from cracking and knowing the communication content.

According to the abovementioned description, the shape and arrangement density of the lattice meshwork (D) constituted by the plurality of the drones (31) can be controlled and changed automatically by the central computer defense system (2) based on the situation analysis of the current invasion. The embodiments are not intended to limit the scope of the shape and arrangement density of the lattice meshwork (D) in the present invention.

Each of the plurality of the drones (31) is provided with a net ejector (34). The central computer defense system (2) transmits a net ejecting order to the drones (31) by wireless communication, making the drones (31) eject the catching nets (35). Moreover, each of the catching nets (35) is provided with a loading object (351) (e.g. a small lead block) on its outer edge so that the catching nets (35) are prone to unfolding by a current of air. In such a case, the plurality of the catching nets (35) are expanded to form a huge intercept network in the air for catching the missiles (4).

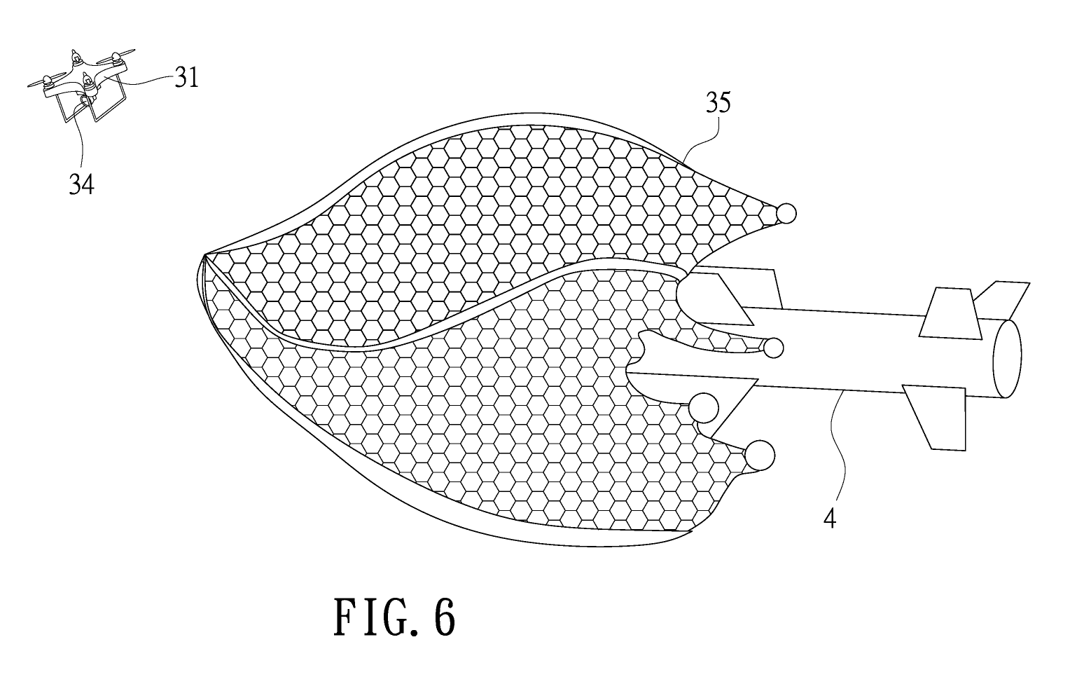

Referring to FIG. 6, a schematic diagram showing a drone successfully intercepts a missile according to the present invention is revealed. When the missile (4) flies into the catching net (35), the catching net (35) catches the missile (4) and thus change the direction of flight of the missile (4). If an intruder is a fighter aircraft which flies into the catching net (35), the wing of the fighter aircraft may be intertwined by the catching net (35) or has a breakdown due to sucking into the catching net (35). Thus, the missile (4) or the fighter aircraft cannot fly towards the intended target anymore, and the security of the national defense military facilities and bases can be ensured.

The central computer defense system (2) can automatically outputs a flight positioning instruction into the plurality of drones (31) based on the situation analysis of the current invasion, so the plurality of drones (31) can aggregate to form multiple layers of the lattice meshwork (D) constituted by the plurality of catching nets (35) for easily intercepting the missile (4).

According to the abovementioned description, the central computer defense system (2) not only deals with the input signal but also conducts a comparison with the internal database (24) based on the use frequency and characteristics of the input signal. If the central computer defense system (2) finds some system information consistent with the input signal, it can offer the system information about an attack threat precisely and show the system information on the information display module (25). Thus, the position and the distance of the input signal can be determined more accurately.

Additionally, the communication between the central computer defense system (2) and the drone bases (3) adopts techniques of wireless regional network and electronic telecommunications as an infrastructure for establishing the land and air defense system, so a powerful wireless network sensing system can also be established. Furthermore, the communication between the central computer defense system (2) and the drones (31) of the drone bases (3) are transmitted with encrypted telecommunications to prevent the enemy from cracking and knowing the communication content.

What is claimed is:

1. A land and air defense system having drones, comprising:
a radar defense warning network having a radar and a signal transmitting module;
a central computer defense system wirelessly connected to the radar defense warning network and having a central computer, a signal receiving module, a processor, a database, and an information display module electrically connected to each other; and
a plurality of drone bases wirelessly connected to the central computer defense system, wherein each of the plurality of drone bases is disposed with a plurality of drones and a wireless charger module, and each of the plurality of drones is disposed with a mobile device and a net ejector.

2. As the land and air defense system having drones claimed in claim 1, wherein the signal transmitting module wirelessly transmits an input signal to the central computer and the signal receiving module of the central computer defense system for comparison by the processor and the database when the radar defense warning network detects a foreign missile or fighter aircraft flying into a defensive area of the radar defense warning network, and the information display module displays a comparison result and simultaneously transmits an output signal to the mobile devices of the plurality of drone bases to actuate the plurality of drones to conduct an air interception if the comparison result indicates that the defensive area is attacked by the foreign missile or fighter aircraft.

3. As the land and air defense system having drones claimed in claim 2, wherein the information display module of the central computer defense system outputs a flight positioning instruction into the plurality of drones in the plurality of drone bases for driving the plurality of drones to fly to an air intercepting position so as to form at least one defense network having a lattice meshwork for intercepting the foreign missile or fighter aircraft.

4. As the land and air defense system having drones claimed in claim 2, wherein the input signal and the output signal are encrypted signals.

5. As the land and air defense system having drones claimed in claim 1, wherein the net ejector has a catching net and receives a net ejecting order from the central computer defense system by wireless communication to eject the catching net.

6. As the land and air defense system having drones claimed in claim 5, wherein an outer edge of the catching net is further disposed with a loading object so that the catching net can be expanded by a current of air.

7. As the land and air defense system having drones claimed in claim 1, wherein the central computer defense system conducts a 24-hour monitoring of airspace and territory by the radar defense warning network established by a ground radar station, a maritime radar station and an aircraft radar.

8. As the land and air defense system having drones claimed in claim 1, wherein the wireless charger module supplies electrical power to the plurality of drones.
